(19) United States
(12) Patent Application Publication
(10) Pub. No.: US 2020/0284314 A1
(43) Pub. Date: Sep. 10, 2020

(54) PARTICLE-BASED VIBRATION REDUCING DEVICES, SYSTEMS, AND METHODS

(71) Applicant: LORD Corporation, Cary, NC (US)

(72) Inventors: David Catanzarite, Edinboro (US); Cody Colpo, Erie (US); Gerald Whiteford, Waterford (US)

(21) Appl. No.: 16/646,268

(22) PCT Filed: Sep. 13, 2018
(86) PCT No.: PCT/US2018/050852

§ 371 Date: Mar. 11, 2020

Related U.S. Application Data
(60) Provisional application No. 62/558,019, filed on Sep. 13, 2017.

(51) Int. Cl. F16F 15/02; F16F 7/01

(52) U.S. Cl. CPC F16F 15/021; F16F 7/10; F16F 2222/08; F16F 7/015

(57) ABSTRACT

Devices (1, 2), systems, and methods for reducing vibration levels of a structure over a broad range of frequencies have one or more chambers (112) that are configured to be coupled to a vibrating structure and a plurality of particles that partially fill each of the one or more chambers (112), where the plurality of particles includes a mixture of two or more types of particles of substantially differing sizes.

### CROSS-REFERENCE TO RELATED APPLICATIONS

This application claims the benefit of U.S. Provisional Patent Application Ser. No. 62/558,019, filed Sep. 13, 2017, the disclosure of which is incorporated herein by reference in its entirety.

### TECHNICAL FIELD

The subject matter disclosed herein relates generally to devices, systems, and methods that attach to a structure for reducing vibration levels over a broad range of frequencies. More particularly, the subject matter disclosed herein relates to a particle-based vibration reducing device.

### BACKGROUND

Vibration of mechanical components may induce component fatigue and excessive localized noise within mechanical systems. For example, in some aircraft engine exhaust bleed valves, premature wear is in some cases attributed to high vibration levels. Conventional vibration damper systems that rely on elastomers or other temperature sensitive materials are unsuitable in the environment (e.g., with high temperatures of 700° F. or greater) in which these systems typically operate. As a result, it would be desirable for a solution to reduce vibration levels experienced in these and other similar systems to extend the useful service life of such devices.

### SUMMARY

In some aspects, a particle-based vibration reducing device includes one or more chambers configured to be coupled to a vibrating structure. A plurality of particles partially fills each of the one or more chambers, wherein the plurality of particles includes a mixture of two or more types of particles of substantially differing sizes.

In some aspects, a particle-based vibration reducing device includes one or more chambers configured to be coupled to a vibrating structure, and a plurality of particles partially fills each of the one or more chambers. The plurality of particles includes a mixture of two or more types of particles of substantially differing sizes, and the plurality of particles is movable within the one or more chambers to reduce vibration in the vibrating structure while generating substantially no heat.

In other aspects, a method for reducing vibration of a vibrating structure includes coupling one or more chambers to the vibrating structure, partially filling each of the one or more chambers with a plurality of particles, wherein the plurality of particles comprises a mixture of two or more types of particles of substantially differing sizes, and sealing each of the one or more chambers to prevent the plurality of particles from escaping the one or more chambers.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 illustrates a particle-based vibration reducing device according to an embodiment of the presently-disclosed subject matter.

FIGS. 2 and 3 illustrate various attachment configurations for a particle-based vibration reducing device according to embodiments of the presently-disclosed subject matter.

FIG. 4 illustrates a particle-based vibration reducing device installed about a mechanical structure according to embodiments of the presently-disclosed subject matter.

FIG. 5A is a graph that illustrates the effectiveness of vibration reducing using a particle-based vibration reducing at a lower natural frequency of a vibrating structure according to embodiments of the presently-disclosed subject matter.

FIG. 5B is a graph that illustrates the effectiveness of vibration reducing using a particle-based vibration reducing at a high natural frequency of a vibrating structure according to embodiments of the presently-disclosed subject matter.

FIG. 6 is a graph that illustrates the effectiveness of vibration reducing of a vibrating structure using different mixtures of materials in a particle-based vibration reducing according to embodiments of the presently-disclosed subject matter.

### DETAILED DESCRIPTION

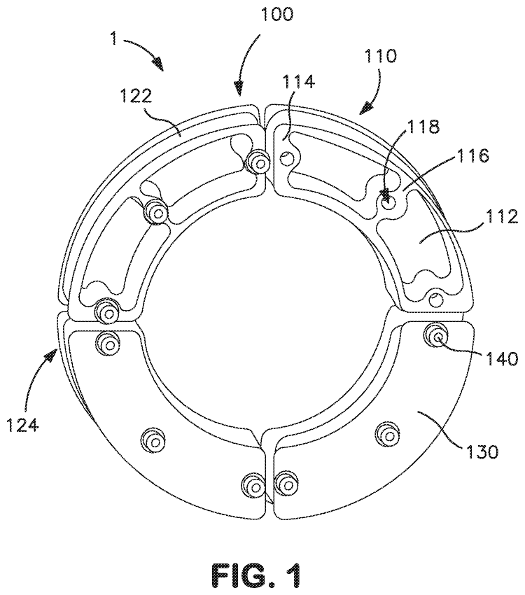

In accordance with this disclosure, devices, systems, and methods for reducing vibration levels of a structure over a broad range of frequencies are provided. In one aspect, a particle-based vibration reducing device is provided in which one or more segments are configured to attach to a structure on a vehicle e.g., an engine exhaust bleed duct on an aircraft. In an example embodiment illustrated in FIG. 1, the device, generally designated 1, includes four segments, generally designated 110, that each form a portion of a ring-shaped housing, generally designated 100, that is configured to encircle the structure. In some embodiments, the housing 100 is created by conventional manufacturing operations. In other embodiments, the housing 100 is created using additive manufacturing methods.

In some embodiments, each segment 110 of the device 1 contains one or more chambers, generally designated 112, that each hold a plurality of particles therein. In the embodiment shown, each segment 110 comprises two chambers 112. The chambers are sealed, such as by covering the chambers 112 with a lid element 130 and securing the lid element in place, such as by using bolts 140 and gaskets as illustrated in FIG. 1, or by brazing, welding, gluing, or any of a variety of other mechanisms for preventing particles from escaping the chambers 112. The chambers 112 are separated from each other internally within segment 110 by internal wall 116, which can have a threaded securing hole, generally designated 118, formed therein. Threaded securing hole 118 is configured to retain a bolt 140 threadably inserted therein through a hole formed through a thickness of the lid element 130. The segments each have a side wall 114 that defines a circumferential extent thereof about housing 100. The one or more chambers 112 can be configured to be either air-tight or breathable with respect to the surrounding environment. In embodiments in which a breathable seal is desired, however, a porous metal, gasket, venting, valves, or other means are provided such that the plurality of particles cannot escape the respective chamber 112 in which such particles are contained. The housing 100 in an assembled state has an inner surface which circumferentially engages the housing 100 against the structure. The housing 100 has, in some embodiments, an outer race, generally designated 124, formed around a perimeter thereof, which can be defined by flanges defined within the front and rear faces of the housing 100.

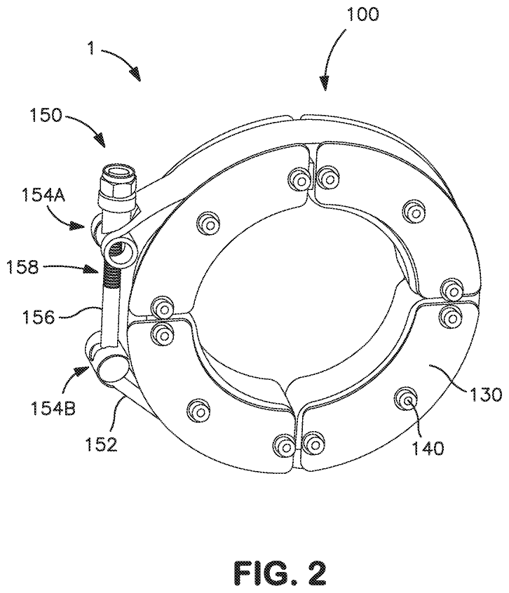

In some embodiments, the one or more segments 110 are coupled to the vibrating structure and/or to one another by any of a variety of attachment mechanisms known in the art. Two examples of such attachment configurations are illustrated in FIGS. 2 and 3. In the embodiment illustrated in FIG. 2, an attachment mechanism, generally designated 150, encircles the housing 100 to maintain the segments 110 in the ring-shaped arrangement. In some embodiments, the attachment mechanism 150 includes a band or strap 152 that extends from a first end 154A to a second end 154B around all or substantially all of the perimeter of the housing 100 and is configured to engage the outer edge of each of the segments 110, such as by engaging the outer race 124. In some embodiments, the first end 154A and the second end 154B are coupled together to maintain a desired tension on strap 152 to hold the segments 110 together. In some embodiments, such coupling is achieved using on or more fastener 156 that engages each of the first end 154A and the second end 154B. In some embodiments, the one or more fastener 156 includes an adjustment mechanism 158 that is operable adjust a tension between the first end 154A and the second end 154B of strap 152, such as by including a threaded surface on the fastener 156 that engages a threaded nut at one of the first end 154A and the second end 154B as illustrated in FIG. 2.

In an alternative embodiment illustrated in FIG. 3, a second configuration of the device, generally designated 2, includes two segments, generally designated 210, that each form a portion of a ring-shaped housing, generally designated 200, that is configured to encircle the structure. In some embodiments, each segment 210 of the device 2 contains one or more chambers, generally designated 212, that each hold a plurality of particles therein. In the embodiment shown, each segment 210 comprises two chambers 212. The chambers are sealed, such as by covering the chambers 212 with a lid element 230 and securing the lid element in place, such as by using bolts 240 and gaskets as illustrated in FIG. 3, or by brazing, welding, gluing, or any of a variety of other mechanisms for preventing particles from escaping the chambers 212. The chambers 212 are separated from each other internally within segment 210 by internal wall 216, which can have a threaded securing hole, generally designated 218, formed therein. Threaded securing hole 218 is configured to retain a bolt 240 threadably inserted therein through a hole formed through a thickness of the lid element 230. The one or more chambers 212 can be configured to be either air-tight or breathable with respect to the surrounding environment. In embodiments in which a breathable seal is desired, however, a porous metal, gasket, venting, valves, or other means are provided such that the plurality of particles cannot escape the respective chamber 212 in which such particles are contained. The housing 200 in an assembled state has an inner surface which circumferentially engages the housing 200 against the structure.

In the embodiment illustrated in FIG. 3, the one or more segments 210 are coupled to the vibrating structure and/or to one another by an attachment mechanism, generally designated 250, to which the segments 210 are secured. In some embodiments, the attachment mechanism 250 includes a band or bracket 220 that is configured to be secured about vibrating structure. In some embodiments, the bracket 220 comprises a plurality of bracket portions that are configured to be fastened together about the vibrating structure, such as by a bolt 252 and nut 254 that couple the bracket portions together. The one or more segments 210 are further attachable to the bracket 220, such as by fasteners, brazing, welding, gluing, or any of a variety of other mechanisms sufficient to secure the components together in the ring-shaped arrangement. In some embodiments, each of the one or more segments 210 includes a coupling segment 215 though which a mounting hole 217 is formed, the mounting hole 217 being configured to receive a fastener therethrough for engaging bracket 220.

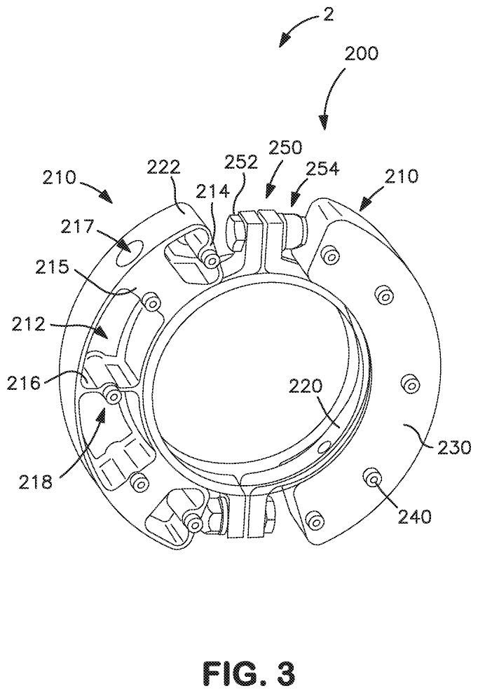

In some embodiments, the device 1 is easily added onto an existing system by clamping around an existing structural element, such as is shown in FIG. 4. In some embodiments, the particular attachment configuration is selected based on the available clearance around the structural element. Alternatively, in some other embodiments, the one or more chambers 112 are formed within a structure. In some embodiments, for example, a canister with a number of chambers 112 is attached inside a tube and is held in place, e.g., with an expanding wedge ring or any of a variety of other means. In other embodiments, a particle-based vibration reducing device according to the presently-disclosed subject matter is designed into an existing void present within the vibrating structure.

Regardless of the particular configuration and connection of the one or more segments 110, the one or more chambers 112 in each segment 110 are partially filled with a plurality of particles. In this way, the device provides effective damping of vibration of the associated structure through a combination of loss mechanisms, which may include friction and momentum exchange. In contrast to conventional damper configurations, an effective reduction in the vibration in the system is provided while generating substantially no heat.

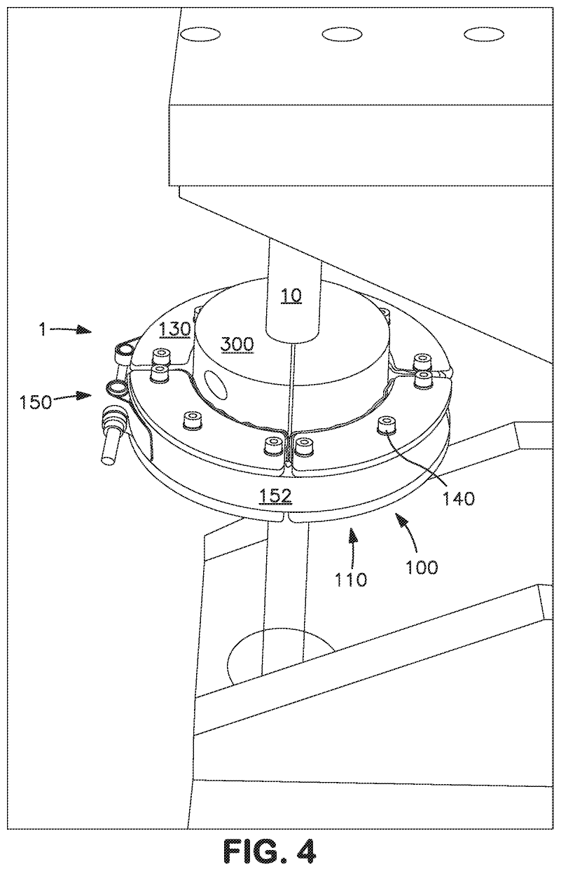

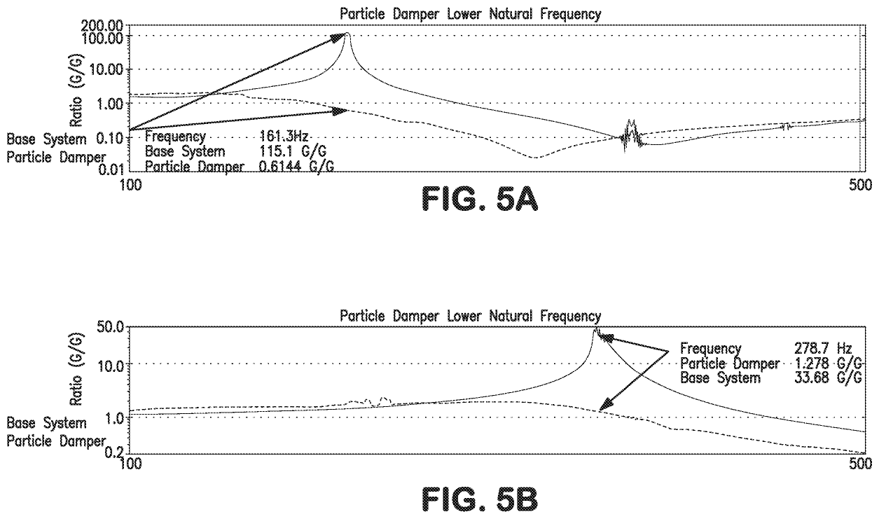

In some embodiments, the particulate fill ratio, which can be described as the selected proportion of a total volume of the chamber 112 that is filled by the particles, is optimized for the vibratory input of the specific application to achieve a desired vibration reducing response. An example of this behavior can be seen in FIGS. 5A and 5B. In some embodiments, by adjusting the free space within the chamber relative to the particle fill, the effect on modal mass of the system can be controlled. Alternatively or in addition, in some embodiments, the number, size, and/or relative spatial orientation of the one or more chambers may be selected to further control the effect of the inertial reaction of the particles on the structure and control resonant characteristics of the system. For example, in some embodiments, distributing the particles among a plurality of chambers about a perimeter of the structure, as is illustrated in the example embodiments of FIGS. 1-4, limits the range of movement of the particles. In this way, the size and arrangement of the chambers can be selected to control particular modes of vibration. In some embodiments, depending on the designed shape of the segments 110 and/or chambers 112, the damping effect produced by the particle-based vibration reducing device is substantially omni-directional.

In some embodiments, the particles contained within the one or more chambers 112 of the device 1 include a mixture of particles of substantially differing sizes. In some embodiments, the particle mix includes a mixture of micron-scale particles, e.g., powdered metal particles, and larger particles, e.g., one or more varieties of ball bearings. In some embodiments, the micron-scale particles have effective particle diameters in a range of 2-40 microns, although those having ordinary skill in the art will understand that particles having diameters outside of this range may still provide desirable results in some applications. In some embodiments, the larger particles are at least an order of magnitude larger than the micron-scale particles, such that the larger particles have an effective diameter that is at least ten times larger than the effective diameter(s) of the micron-scale particles. In some embodiments, ball bearing sizes of about 0.0625 inches (about 1.5875 millimeters) and about 0.375 inches (about 9.525 millimeters) in diameter are used with the micron-scale particles, although those having skill in the art will understand that ball bearings having different sizes may still provide desirable results. In such a mixture, in some embodiments, the micron-scale particles react to vibration in a substantially fluid-like manner compared to the movement of the larger particles, and this differentiation in the response by the various components in the mixture provides an aggregate vibration reducing response that exhibits an improvement over conventional dampers and other vibrational absorbers.

In some embodiments, the particular ratio of components within the mixture can be adjusted to control the vibration reducing response of the particle-based vibration reducing device based on a given application. From the testing completed at this time, the inclusion of smaller ball bearings, e.g., those having an approximately about 0.0625 inches (about 1.5875 millimeters) diameter, appears to result in a steeper/quicker roll-off rate after passing through the natural frequency of the system, whereas the inclusion of larger ball bearings, e.g., those having about 0.375 inches (about 9.525 millimeters) diameter, seems to knock down the transmissibility of vibration in general. In one embodiment, a mixture including 9 parts (by weight) micron-scale particles, 5 parts about 0.0625 inches (about 1.5875 millimeters) ball bearings, and 2.5 parts about 0.375 inches (about 9.525 millimeters) ball bearings has been shown to provide effective damping, although those having ordinary skill in the art will understand that the sizes and/or the number of different sizes of the ball bearings is not limited to such size ranges for other applications.

In some embodiments, each of the types of particles within the mixture are selected from any of a variety of materials to adjust one or more of the mass of the particles within the particle-based vibration reducing device and/or to select particular material properties. In some embodiments, for example, the particles are all metallic materials, which can help to resist deleterious effects of high temperature environments. In addition, a material for one or more of the particle types can be selected to adjust the density of the particles. In some embodiments, the use of relatively higher-density materials for the micron-scale particles provides more favorable reductions in vibration of the system compared to mixtures that use lower-density particles, even when the particles have substantially similar particle sizes.

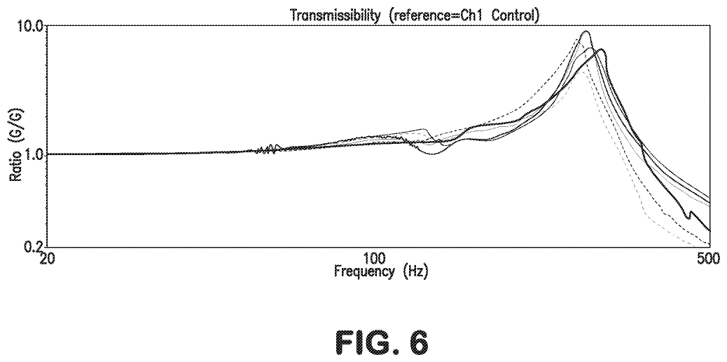

Regardless of the particular characteristics of the mixture, micron-scale particles are mixed with one or more type of larger particles at a ratio selected for the particular application and sealed within the compartment, as discussed above. Current testing indicates that a mixture of substantially different sizes of particles (e.g., ball bearings in powder) is significantly more effective than a single size particle. Such an improvement is illustrated in FIG. 6, where the use of different particle mixes in a particle-based vibration reducing device according to the presently-disclosed subject matter are shown to alter the response amplitude, natural frequency, and roll-off of vibration. The particle mixes tested in FIG. 6 include a mixture of 0.31 parts stainless steel powder with 0.5 parts about 0.0625 inches (about 1.5875 millimeters) ball bearings and 0.25 part about 0.375 inches (about 9.525 millimeters) ball bearings; 0.45 parts iron powder with 0.5 parts about 0.0625 inches (about 1.5875 millimeters) ball bearings and 0.25 part about 0.375 inches (about 9.525 millimeters) ball bearings; 0.287 parts Inconel powder with 0.5 parts about 0.0625 inches (about 1.5875 millimeters) ball bearings and 0.25 part about 0.375 inches (about 9.525 millimeters) ball bearings; 0.3 parts Inconel powder with 0.75 parts about 0.0625 inches (about 1.5875 millimeters) ball bearings and 0.25 part about 0.375 inches (about 9.525 millimeters) ball bearings; 0.2 parts Inconel powder with 0.5 parts about 0.0625 inches (about 1.5875 millimeters) ball bearings and 0.25 part about 0.375 inches (about 9.525 millimeters) ball bearings; and with iron powder only.

Those having ordinary skill in the art will understand that this improvement in the effectiveness of a particle-based vibration reducing device can be achieved regardless of the particular configuration of the device into which the particles are sealed. In any configuration, one or more of the materials selected for the particles, the sizes of the various particles, the ratio of different particle types in the mixture, or the fill ratio can be tuned to adjust the impact on vibration reducing properties and achieve a desired vibration reducing response, such as by varying the impact on natural frequency, e.g., by further altering the effective modal mass, while simultaneously reducing vibration amplitude experienced by the component. Furthermore, in some embodiments, by adjusting one or more characteristics of the mixture particles, a device according to the present subject matter can be designed for a broad range of frequency applications. In some embodiments, the vibration reduction provided is less sensitive to the frequency of vibration than tuned mass dampers and, therefore, can effectively impact multiple modes within a structure.

One further advantage of the present devices, systems, and methods is that the particle-based vibration reducing device according to the presently-disclosed subject matter generates very little heat during operation. As discussed above, in conventional damper designs, damping is provided at least in part through a conversion of motion into heat. In contrast, the vibration-reducing effect provided by the present devices, systems, and methods is achieved without such thermal losses and, thus, little to no thermal generation and substantially no rise in temperature occurs in surrounding structures during effective damping in some embodiments of the presently-disclosed subject matter.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A vibration reducing device comprising:
one or more chambers configured to be coupled to a vibrating structure; and
a plurality of particles partially filling each of the one or more chambers, wherein the plurality of particles comprises a mixture of two or more types of particles of substantially differing sizes.

2. The vibration reducing device of claim 1, wherein each of the one or more chambers are each sealed for preventing the plurality of particles from escaping the one or more chambers.

3. The vibration reducing device of claim 2, comprising at least one lid element secured over the one or more chambers.

4. The vibration reducing device of claim 1, wherein the one or more chambers are arranged in one or more device segments arranged about the vibrating structure.

5. The vibration reducing device of claim 1, wherein the plurality of particles fill a selected proportion of a total volume of each of the chambers to achieve a desired vibration reducing response.

6. The vibration reducing device of claim 1, wherein the plurality of particles comprises:
a plurality of micron-scale particles; and
a plurality of ball bearings having diameters at least an order of magnitude larger than the plurality of micron-scale particles.

7. The vibration reducing device of claim 6, wherein the plurality of micron-scale particles have effective particle diameters in a range of 2-40 microns.

8. The vibration reducing device of claim 6, wherein the plurality of ball bearings comprises ball bearings having two or more different diameters.

9. The vibration reducing device of claim 8, wherein the plurality of ball bearings comprises:
a first set of ball bearings having diameters of approximately about 0.0625 inches (about 1.5875 millimeters); and
a second set of ball bearings having diameters of approximately about 0.375 inches (about 9.525 millimeters).

10. The vibration reducing device of claim 1, wherein the plurality of particles comprises metal particles.

11. A vibration reducing device comprising:
one or more chambers configured to be coupled to a vibrating structure; and
a plurality of particles partially filling each of the one or more chambers, wherein the plurality of particles comprises a mixture of two or more types of particles of substantially differing sizes;
wherein the plurality of particles is movable within the one or more chambers to reduce vibration in the vibrating structure while generating substantially no heat.

12. The vibration reducing device of claim 11, wherein each of the one or more chambers are each sealed for preventing the plurality of particles from escaping the one or more chambers.

13. The vibration reducing device of claim 12, comprising at least one lid element secured over the one or more chambers.

14. The vibration reducing device of claim 11, wherein the one or more chambers are arranged in one or more device segments arranged about the vibrating structure.

15. The vibration reducing device of claim 11, wherein the plurality of particles fill a selected proportion of a total volume of each of the chambers to achieve a desired vibration reducing response.

16. The vibration reducing device of claim 11, wherein the plurality of particles comprises:
a plurality of micron-scale particles; and
a plurality of ball bearings having diameters at least an order of magnitude larger than the plurality of micron-scale particles.

17. The vibration reducing device of claim 16, wherein the plurality of micron-scale particles have effective particle diameters in a range of 2-40 microns.

18. The vibration reducing device of claim 16, wherein the plurality of ball bearings comprises ball bearings having two or more different diameters.

19. The vibration reducing device of claim 18, wherein the plurality of ball bearings comprises:
a first set of ball bearings having diameters of approximately about 0.0625 inches (about 1.5875 millimeters); and
a second set of ball bearings having diameters of approximately about 0.375 inches (about 9.525 millimeters).

20. The vibration reducing device of claim 11, wherein the plurality of particles comprises metal particles.

21. A method for reducing vibration of a vibrating structure, the method comprising:
partially filling each of one or more chambers with a plurality of particles, wherein the plurality of particles comprises a mixture of two or more types of particles of substantially differing sizes;
sealing each of the one or more chambers to prevent the plurality of particles from escaping the one or more chambers; and
coupling the one or more chambers to the vibrating structure.

22. The method of claim 21, wherein partially filling each of the one or more chambers with a plurality of particles comprises filling a selected proportion of a total volume of each of the chambers with the plurality of particles to achieve a desired vibration reducing response.

23. The method of claim 21, wherein the plurality of particles comprises:
a plurality of micron-scale particles; and
a plurality of ball bearings having diameters at least an order of magnitude larger than the plurality of micron-scale particles.

24. The method of claim 23, wherein the plurality of micron-scale particles have effective particle diameters in a range of 2-40 microns.

25. The method of claim 23, wherein the plurality of ball bearings comprises ball bearings having two or more different diameters.

26. The method of claim 25, wherein the plurality of ball bearings comprises:
a first set of ball bearings having diameters of approximately about 0.0625 inches (about 1.5875 millimeters); and
a second set of ball bearings having diameters of approximately about 0.375 inches (about 9.525 millimeters).

27. The method of claim 21, wherein the plurality of particles comprises metal particles.

28. The method of claim 21, wherein sealing each of the one or more chambers comprises securing at least one lid element over the one or more chambers.

29. The method of claim 21, wherein coupling the one or more chambers to the vibrating structure comprises arranging the one or more chambers in one or more device segments arranged about the vibrating structure.
